(19) United States
(12) Patent Application Publication
(10) Pub. No.: US 2007/0048596 A1
(43) Pub. Date: Mar. 1, 2007

(54) Lithium ion secondary battery

(76) Inventors: Masaki Hasegawa, Osaka (JP); Yasuhiko Bito, Osaka (JP)

Correspondence Address: MCDERMOTT WILL & EMERY LLP, 600 13TH STREET, N.W., WASHINGTON, DC, 20005-3096, US

(21) Appl. No.: 11/503,300

(22) Filed: Aug. 14, 2006

(30) Foreign Application Priority Data
Aug. 25, 2005 (JP) 2005-243860

(51) Int. Cl. H01M 10/50; H01M 4/58; H01M 4/50; H01M 4/42; H01M 4/52; H01M 4/48; H02J 7/04

(52) U.S. Cl. 429/62; 429/231.95; 429/223; 429/231.3; 429/224; 429/231.6; 429/231.2; 429/220; 429/229; 429/221; 429/231.5; 320/150

(57) ABSTRACT

A lithium ion secondary battery that offers high thermal stability. The lithium ion secondary battery includes a positive electrode capable of absorbing and desorbing lithium ions, a negative electrode capable of absorbing and desorbing lithium ions, and a non-aqueous electrolyte, wherein a difference ΔT between a temperature T₁ and a temperature T₂ is equal to 50° C. or greater, where the T₁ is a temperature at which the heat generation rate of the positive electrode in a charged state reaches the maximum, and the T₂ is a temperature at which the heat generation rate of the negative electrode in a charged state reaches the maximum.

### FIELD OF THE INVENTION

The present invention relates to a lithium ion secondary battery, and more particularly to an improvement in the safety of lithium ion secondary battery.

### BACKGROUND OF THE INVENTION

Lithium ion secondary batteries, which offer high voltage and high energy density, are widely used as a power source for a number of mobile communication devices and portable electronic devices. With rapid advancement in miniaturization and performance of these devices in recent years, demand is growing for lithium ion secondary batteries having higher energy density.

With this trend toward higher energy density lithium ion secondary batteries, an increasing importance is placed on ensuring thermal stability of lithium ion secondary batteries. For example, in the event where a lithium ion secondary battery is charged above its rated capacity due to a malfunction of a device equipped with the battery and become overcharged, or where an internal short-circuit occurs in a lithium ion secondary battery, the lithium ion secondary battery can overheat. The temperature will rise significantly at the area where an internal short-circuit has occurred or the center of the battery. The battery's surface temperature also rises due to the heat generated inside the battery.

For the viewpoint of improving thermal stability of lithium ion secondary batteries, attempts have been made to improve component materials of the batteries. It is generally accepted that in a lithium ion secondary battery in a charged state, the thermal stability of the electrode active materials decreases. Particularly, the thermal stability of the positive electrode decreases significantly.

The mechanism for the battery overheating is generally considered to proceed as follows. The temperature inside the battery rises first. When the temperature exceeds the heat generation starting temperature of the positive electrode having low thermal stability, the positive electrode starts to generate heat. The heat generation of the positive electrode causes a further temperature increase in the battery, reaching the heat generation starting temperature of the negative electrode. When the negative electrode starts to generate heat, the temperature inside the battery rises further.

In other words, if a lithium ion secondary battery is overcharged, for example, due to a malfunction of a charger, the temperature inside the battery will increase significantly. As a result, the battery's surface temperature also increases.

In light of the above, it can be assumed that improving the thermal stability of positive electrodes can lead to enhanced thermal stability of lithium ion secondary batteries. Based on this assumption, Japanese Laid-Open Patent Publications Nos. 2001-52684 and 2003-132883 propose to enhance the thermal stability of positive electrode active materials in a charged state. However, merely improving positive electrodes is not enough because once the temperature inside the battery reaches the heat generation starting temperature of the positive electrode, subsequent temperature increase is difficult to control.

### BRIEF SUMMARY OF THE INVENTION

The present invention relates to a lithium ion secondary battery comprising a positive electrode capable of absorbing and desorbing lithium ions, a negative electrode capable of absorbing and desorbing lithium ions, and a non-aqueous electrolyte, wherein a difference ΔT between a temperature T₁ and a temperature T₂ is equal to 50° C. or greater, where the T₁ is a temperature at which the heat generation rate of the positive electrode in a charged state reaches the maximum, and the T₂ is a temperature at which the heat generation rate of the negative electrode in a charged state reaches the maximum.

The temperature T₁ is preferably not less than 215° C.

The positive electrode active material is preferably a powdered material in terms of reaction area and ease of electrode production. The positive electrode preferably comprises a positive electrode active material, a conductive material and a binder, in terms of conductivity and strength. The positive electrode active material is preferably represented by the formula LiₓCo_{1-y-z}Ni_{y}M_{z}O₂, where 0.95≦x≦1.1, 0≦y≦0.9, 0≦z≦0.5, and M is at least one element selected from the group consisting of Al, Mn, Mg, Ti, V, Fe, Cu and Zn, in terms of charge/discharge capacity.

The negative electrode active material is preferably a powdered material in terms of reaction area and ease of electrode production. The negative electrode preferably comprises a negative electrode active material and a binder, in terms of strength. The negative electrode active material preferably comprises at least one selected from the group consisting of carbon material, Si, Si alloy, Si oxide, Sn, Sn alloy and Sn oxide, in terms of charge/discharge capacity.

The temperatures T₁ and T₂ can be obtained by subjecting the positive and negative electrodes removed from the battery in a charged state to accelerating rate calorimetry (ARC measurement). As used herein, the “battery in a charged state” means a battery charged by a charger until the battery voltage reaches an end-of-charge voltage (the upper limit voltage to which the battery is charged).

According to the present invention, it is possible to suppress the rise of surface temperature of a lithium ion secondary battery in an overcharged state.

The present invention further relates to a charging system for a lithium ion secondary battery comprising a lithium ion secondary battery and a charger for charging the lithium ion secondary battery, the lithium ion secondary battery comprising a positive electrode capable of absorbing and desorbing lithium ions, a negative electrode capable of absorbing and desorbing lithium ions, and a non-aqueous electrolyte, wherein the charger has a function to terminate charging when the lithium ion secondary battery is at a state of charge of not less than 90% relative to its rated capacity, and a difference ΔT between a temperature T₁ and a temperature T₂ is equal to 50° C. or greater, where the T₁ is a temperature at which the heat generation rate of the positive electrode contained in the lithium ion secondary battery at a state of charge of not less than 90% relative to its rated capacity reaches the maximum, and the T₂ is a temperature at which the heat generation rate of the negative electrode contained in the lithium ion secondary battery at a state of charge of not less than 90% relative to its rated capacity reaches the maximum.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWING

FIG. 1 is a vertical cross sectional view of a lithium ion secondary battery according to one embodiment of the present invention.

### DETAILED DESCRIPTION OF THE INVENTION

In a lithium ion secondary battery in an overcharged state, a temperature increase in the battery is considered to occur as follows.

In an overcharged state, the electrochemical reactivity of the electrode active materials decreases, increasing the internal resistance of the battery, and generating Joule heat. Due to the Joule heat, the temperature inside the battery rises. When the temperature reaches the heat generation starting temperature of the positive electrode having low thermal stability, the positive electrode starts to generate heat. The heat generation of the positive electrode causes a further temperature increase inside the battery, reaching the heat generation starting temperature of the negative electrode. When the negative electrode starts to generate heat, the temperature inside the battery rises further.

In a lithium ion secondary battery in a charged state, the positive electrode has lower thermal stability than the negative electrode, and thus the heat generation at the positive electrode precedes the heat generation at the negative electrode. Accordingly, enhancing the thermal stability of the positive electrode helps to improve the thermal stability of the entire battery. When the temperature inside the battery exceeds the heat generation stating temperature of the positive electrode due to Joule heat, however, subsequent temperature increase in the positive and negative electrodes cannot be suppressed.

In order to reveal the relationship between the heat generation temperatures of the positive and negative electrodes and the thermal stability of the battery, the present inventors conducted the following experiment.

First, batteries of various compositions were subjected to an overcharge test using a current level of 1 C (a current level at which a quantity of electricity equal to the rated capacity of a battery is charged or discharged in one hour) at a low temperature (0° C.), and the surface temperature of each battery was measured. Then, from each of the charged batteries, the positive and negative electrodes were removed, and the thermal behavior of the positive and negative electrodes in a charged state was measured by an accelerating rate calorimeter. Subsequently, the temperature T₁ at which the heat generation rate of the positive electrode in a charged state reached the maximum and the temperature T₂ at which the heat generation rate of the negative electrode in a charged state reached the maximum were determined. As a result, it was found that when a difference ΔT between the temperature T₁ and the temperature T₂ was equal to 50° C. or greater, the surface temperature of the batteries was suppressed to not greater than 60° C. even if overcharging was performed at a current level of 1 C at 0° C.

Based on the above finding, the present invention proposes a lithium ion secondary battery comprising a positive electrode capable of absorbing and desorbing lithium ions, a negative electrode capable of absorbing and desorbing lithium ions, and a non-aqueous electrolyte, wherein a difference ΔT between a temperature T₁ at which the heat generation rate of the positive electrode in a charged state reaches the maximum and a temperature T₂ at which the heat generation rate of the negative electrode in a charged state reaches the maximum is equal to 50° C. or greater. From the viewpoint of preventing the surface temperature of a lithium ion secondary battery in an overcharged state from rising significantly, the ΔT is preferably 55° C. or greater.

The temperature T₁ is, for example, not less than 215° C., or preferably not less than 250° C. By setting the temperature T₁ to not less than 215° C., the surface temperature of the battery in an overcharged state can be suppressed to a lower level.

The temperature T₂ is preferably not less than 265° C. By setting the temperature T₂ to not less than 265° C., the surface temperature of the battery in an overcharged state can be suppressed to a lower level.

From the viewpoint of safety, the maximum surface temperature of a battery is preferably 60° C. or lower when the battery is subjected to an overcharge test (a test in which a battery is charged to 150% of its rated capacity) using a current level of 1 C at 0° C. If a battery whose surface temperature rises over 60° C. during such overcharge test at 0° C. reaches an overcharged state at room temperature, its surface temperature rises very high, which may cause malfunction of a device equipped with the battery. For example, the malfunction of a control circuit can allow the battery to reach an overcharged state at room temperature.

Even if a battery whose surface temperature does not rise over 60° C. during such overcharge test at 0° C. reaches an overcharged state at room temperature, its surface temperature does not rise so high. Accordingly, the malfunction of a device resulting from a temperature rise of the battery can be avoided.

In the present invention, the following positive electrode, negative electrode and non-aqueous electrolyte can be used, for example.

(i) Positive Electrode

The positive electrode comprises, for example, a positive electrode active material, a conductive material and a binder. The positive electrode active material is preferably a lithium composite oxide represented by the formula LiₓCo_{1-y-z}Ni_{y}M_{z}O₂, where 0.95≦x≦1.1, 0≦y≦0.9, 0≦z≦0.5 and M is at least one element selected from the group consisting of Al, Mn, Mg, Ti, V, Fe, Cu and Zn.

The morphology of the lithium composite oxide is not specifically limited. There are, for example, two cases: one where primary particles form the active material particles; and the other where secondary particles form the active material particles. A plurality of active material particles may aggregate and form secondary particles. The average particle size of the active material particles is not specifically limited. A preferred average particle size is 1 to 30 μm, and particularly preferably 10 to 30 μm. The average particle size can be measured by a wet type laser particle size distribution analyzer available from Microtrac Inc. In this case, a particle size at 50% accumulation in a particle size distribution based on volume (median value: D₅₀) can be regarded as the average particle size of the active material particles.

The element M in the lithium composite oxide is preferably at least one selected from the group consisting of Mn, Al, Mg, Ti, V, Fe, Cu and Zn. These elements as the element M can be contained, either singly or in combination, in the lithium composite oxide. Among the above, Mn, Al and Mg are particularly preferred because they are effective in improving the thermal stability of the lithium composite oxide.

Although the value x representing the amount of Li fluctuates during charge/discharge of the battery, usually, the value x in the initial state (immediately after the synthesis of the lithium composite oxide) is 0.95≦x≦1.1.

The value y representing the amount of Ni is preferably 0≦y≦0.9 or 0.3≦y≦0.85. The use of a positive electrode active material containing Ni can achieve high capacity.

The atomic ratio a of Co to the total of Co, Ni and the element M is preferably 0.05≦a≦0.5, and more preferably 0.05≦a≦0.35.

When the element M comprises Al, the atomic ratio b of Al to the total of Co, Ni and the element M is preferably 0.005≦b≦0.1, and more preferably 0.01≦b≦0.08.

When the element M comprises Mn, the atomic ratio c of Mn to the total of Co, Ni and the element M is preferably 0.005≦c≦0.5, and more preferably 0.01≦c≦0.35.

When the element M comprises Mg, the atomic ratio d of Mg to the total of Co, Ni and the element M is preferably 0.00002≦d≦0.1, and more preferably 0.0001≦d≦0.05.

The conductive material contained in the positive electrode can be anything as long as it is an electron conductive material that is chemically stable in the battery. Examples of the conductive material include: graphites such as natural graphite (e.g., flake graphite), artificial graphite and expanded graphite; carbon blacks such as acetylene black, ketjen black, channel black, furnace black, lamp black and thermal black; and conductive fibers such as carbon fiber and metal fiber. They may be used singly or in any combination of two or more. Among the above, preferred is carbon black because it comprises fine particles and is highly conductive. Particularly preferred is acetylene black. The amount of the conductive material is, for example, 2 to 15 parts by weight relative to 100 parts by weight of the positive electrode active material, or preferably 3 to 10 parts by weight.

The binder contained in the positive electrode can be any resin conventionally used for positive electrode binders for lithium ion secondary batteries. Examples of the binder include polyethylene, polypropylene, polytetrafluoroethylene (PTFE), polyvinylidene fluoride (PVDF), styrene butadiene rubber, tetrafluoroethylene-hexafluoropropylene copolymer (FEP), tetrafluoroethylene-perfluoroalkylvinylether copolymer (PFA), vinylidene fluoride-hexafluoropropylene copolymer, vinylidene fluoride-chlorotrifluoroethylene copolymer, ethylene-tetrafluoroethylene copolymer (ETFE), polychlorotrifluoroethylene (PCTFE), vinylidene fluoride-pentafluoropropylene copolymer, propylene-tetrafluoroethylene copolymer, ethylene-chlorotrifluoroethylene copolymer (ECTFE), vinylidene fluoride-hexafluoropropylene-tetrafluoroethylene copolymer, vinylidene fluoride-perfluoromethylvinylether-tetrafluoroethylene copolymer, ethylene-acrylic acid copolymer, ethylene-methacrylic acid copolymer, ethylene-methyl acrylate copolymer, and ethylene-methyl methacrylate copolymer. They may be used singly or in any combination of two or more. They may be crosslinked with Na ions. Among the above, preferred is PTFE because favorable electrode strength can be obtained without impairing the electrode reaction.

There is no specific limitation on the method for producing the positive electrode and the shape of the positive electrode. Usually, a positive electrode material mixture containing a positive electrode active material, a conductive material and a binder is carried onto a strip-shaped positive electrode current collector to form a positive electrode. Alternatively, the positive electrode material mixture is dispersed in a liquid component to make a slurry. The slurry is applied onto a positive electrode current collector, followed by drying, whereby the positive electrode material mixture is carried onto the positive electrode current collector. Still alternatively, the positive electrode material mixture is formed into a sheet or pellet to produce a positive electrode.

The positive electrode current collector can be, for example, a foil or sheet comprising aluminum, stainless steel, nickel or titanium. In terms of cost, workability and stability, an aluminum foil and an aluminum alloy foil are preferred. On the surface of the foil or sheet, a layer made of carbon or titanium may be applied, or an oxide layer may be formed. The surface of the foil or sheet may be roughened. A net, punched sheet, lath, porous sheet or foam may also be used. The positive electrode current collector may be a non-electron conductive resin sheet having a conductive layer formed on the surface thereof. The resin sheet may be made of polyethylene terephthalate, polyethylene naphthalate or polyphenylene sulfide. The thickness of the positive electrode current collector is not specifically limited, and it can be 1 to 500 μm, for example.

(ii) Negative Electrode

The negative electrode comprises, for example, a negative electrode active material and a binder. The negative electrode active material can be a material capable of electrochemically charging and discharging lithium. Examples of the negative electrode active material include carbon material, metal, alloy and metal oxide. In terms of charge/discharge capacity and cycle characteristics, alloy is preferred.

The carbon material can be, for example, natural graphite, artificial graphite or non-graphitizable carbon (hard carbon).

Examples of the metal and alloy include simple substance of silicon, silicon alloy, simple substance of tin, tin alloy, simple substance of germanium and germanium alloy. Among them, simple substance of silicon and silicon alloy are preferred. The metal element other than silicon contained in the silicon alloy is preferably a metal element incapable of forming an alloy with lithium. The metal element incapable of forming an alloy with lithium can be anything as long as it is an electron conductor that is chemically stable. Preferred examples thereof include titanium, copper and nickel. They may be contained, either singly or in combination, in the silicon alloy.

When the silicon alloy contains Ti, the molar ratio Ti/Si is preferably 0<Ti/Si<2, particularly preferably 0.1≦Ti/Si≦1.0. When the silicon alloy contains Cu, the molar ratio Cu/Si is preferably 0<Cu/Si<4, particularly preferably 0.1≦Cu/Si≦2.0. When the silicon alloy contains Ni, the molar ratio Ni/Si is preferably 0<Ni/Si<2, particularly preferably 0.1≦Ni/Si≦1.0.

Examples of the metal oxide include silicon oxide, tin oxide and germanium oxide. Among them, particularly preferred is a silicon oxide. The silicon oxide preferably has a composition represented by the general formula SiOₓ (0<x<2). More preferably, in the general formula, the value x representing the amount of oxygen element is 0.01≦x≦1.

The binder contained in the negative electrode may be any resin conventionally used for negative electrode binders for lithium ion secondary batteries. Examples of the binder include styrene butadiene rubber (SBR), polyethylene, polypropylene, polytetrafluoroethylene (PTFE), polyvinylidene fluoride (PVDF), tetrafluoroethylene-hexafluoropropylene copolymer (FEP), tetrafluoroethylene-perfluoroalkylvinylether copolymer (PFA), vinylidene fluoride-hexafluoropropylene copolymer, vinylidene fluoride-chlorotrifluoroethylene copolymer, ethylene-tetrafluoroethylene copolymer (ETFE), polychlorotrifluoroethylene (PCTFE), vinylidene fluoride-pentafluoropropylene copolymer, propylene-tetrafluoroethylene copolymer, ethylene-chlorotrifluoroethylene copolymer (ECTFE), vinylidene fluoride-hexafluoropropylene-tetrafluoroethylene copolymer, vinylidene fluoride-perfluoromethylvinylether-tetrafluoroethylene copolymer, ethylene-acrylic acid copolymer, ethylene-methacrylic acid copolymer, ethylene-methyl acrylate copolymer, and ethylene-methyl methacrylate copolymer. They may be used singly or in any combination of two or more. They may be crosslinked with Na ions. In terms of binding strength, SBR is particularly preferred. SBR may contain, in addition to a styrene unit and a butadiene unit, other monomer unit(s).

The negative electrode may further contain a conductive material. The conductive material contained in the negative electrode can be anything as long as it is an electron conductive material that is chemically stable in the battery. Examples of the conductive material include: graphites such as natural graphite (e.g., flake graphite), artificial graphite and expanded graphite; carbon blacks such as acetylene black, ketjen black, channel black, furnace black, lamp black and thermal black; and conductive fibers such as carbon fiber and metal fiber. They may be used singly or in any combination of two or more. Among the above, preferred is carbon black because it comprises fine particles and is highly conductive. Particularly preferred is acetylene black. The amount of the conductive material is, for example, 2 to 15 parts by weight relative to 100 parts by weight of the negative electrode active material, or preferably 3 to 10 parts by weight.

There is no specific limitation on the method for producing the negative electrode and the shape of the negative electrode. Usually, a negative electrode material mixture containing a negative electrode active material, a binder, and optionally a conductive material is carried onto a strip-shaped negative electrode current collector to form a negative electrode. Alternatively, the negative electrode material mixture is dispersed in a liquid component to make a slurry. The slurry is applied onto a negative electrode current collector, followed by drying, whereby the negative electrode material mixture is carried onto the negative electrode current collector. Still alternatively, the negative electrode material mixture is formed into a sheet or pellet to produce a negative electrode.

The negative electrode current collector can be, for example, a foil or sheet comprising stainless steel, nickel, copper or titanium. In terms of cost, workability and stability, a copper foil and a copper alloy foil are preferred. On the surface of the foil or sheet, a layer made of carbon, titanium or nickel may be applied, or an oxide layer may be formed. The surface of the foil or sheet may be roughened. A net, punched sheet, lath, porous sheet or foam may also be used. The negative electrode current collector may be a non-electron conductive resin sheet having a conductive layer formed on the surface thereof. The resin sheet may be made of polyethylene terephthalate, polyethylene naphthalate or polyphenylene sulfide. The thickness of the negative electrode current collector is not specifically limited, and it can be 1 to 500 μm, for example.

The non-aqueous electrolyte is preferably a non-aqueous solvent dissolving a lithium salt.

Examples of the non-aqueous solvent include: cyclic carbonates such as ethylene carbonate (EC), propylene carbonate (PC) and butylene carbonate (BC); linear carbonates such as dimethyl carbonate (DMC), diethyl carbonate (DEC), ethyl methyl carbonate (EMC) and dipropyl carbonate (DPC); aliphatic carboxylic acid esters such as methyl formate, methyl acetate, methyl propionate and ethyl propionate; lactones such as γ-butyrolactone and γ-valerolactone; linear ethers such as 1,2-dimethoxyethane (DME), 1,2-diethoxyethane (DEE) and ethoxymethoxyethane (EME); cyclic ethers such as tetrahydrofuran and 2-methyltetrahydrofuran; dimethyl sulfoxide; 1,3-dioxolane; formamide; acetamide; dimethylformamide; dioxolane; acetonitrile; propylnitrile; nitromethane; ethyl monoglyme; phosphoric acid triester; trimethoxymethane; dioxolane derivative; sulfolane; methylsulfolane; 1,3-dimethyl-2-imidazolidinone; 3-methyl-2-oxazolidinone; propylene carbonate derivative; tetrahydrofuran derivative; ethyl ether; 1,3-propanesultone; anisole; dimethyl sulfoxide; and N-methyl-2-pyrrolidone. They may be used singly or in any combination of two or more. Particularly preferred is a solvent mixture of a cyclic carbonate and a linear carbonate or a solvent mixture of a cyclic carbonate, a linear carbonate and an aliphatic carboxylic acid ester.

Examples of the lithium salt dissolved in the non-aqueous solvent include LiClO₄, LiBF₄, LiPF₆, LiAlCl₄, LiSbF₆, LiSCN, LiCl, LiCF₃SO₃, LiCF₃CO₂, Li(CF₃SO₂)₂, LiAsF₆, LiN(CF₃SO₂) 2, LiB₁₀Cl₁₀, lithium lower aliphatic carboxylate, LiCl, LiBr, LiI, chloroboran lithium, lithium tetraphenylborate and lithium imide. They may be used singly or in any combination of two or more. It is, however, preferred to use at least LiPF₆. The amount of the lithium salt dissolved in the non-aqueous solvent is not specifically limited. Preferably, the lithium salt concentration in the non-aqueous solvent is 0.2 to 2 mol/L, and more preferably 0.5 to 1.5 mol/L.

For the purpose of improving the charge/discharge characteristics of the battery, the non-aqueous electrolyte may further contain an additive. The additive is preferably at least one selected from the group consisting of vinylene carbonate, vinyl ethylene carbonate, phosphazene and fluorobenzene. An appropriate amount of the additive is 0.5 to 20 wt % of the non-aqueous electrolyte.

Usually, a separator needs to be disposed between the positive and negative electrodes. As the separator, an insulating microporous thin film having high ion permeability and a certain mechanical strength is preferably used. The microporous thin film preferably closes its pores at a certain temperature and preferably functions to increase resistance. The microporous thin film is preferably made of polyolefin such as polypropylene or polyethylene because they have excellent chemical resistance to organic electrolytes and are hydrophobic. A sheet, non-woven fabric or woven fabric made of glass fiber or the like can also be used. The separator has a pore size of, for example, 0.01 to 1 μm. The thickness of the separator is usually 10 to 300 μm. The porosity of the separator is usually 30 to 80%.

There is no specific limitation on the structure of the lithium ion secondary battery of the present invention. The present invention is applicable to any type of battery as long as the battery has a structure in which the positive and negative electrodes face each other with the separator or electrolyte interposed therebetween. The battery can have the shape of, for example, a coin, sheet, cylinder or prism. The lithium ion secondary battery of the present invention can be a large battery for use in electric vehicles, etc., or a small battery for use in personal digital assistants, portable electronic devices, etc. The lithium ion secondary battery of the present invention is also applicable to compact electrical energy storage systems for home use, two-wheeled vehicles, electric vehicles, hybrid electric vehicles, etc.

The present invention will be described in further detail below. It should be, however, noted that the present invention is not limited to the examples given below.

### EXAMPLE 1

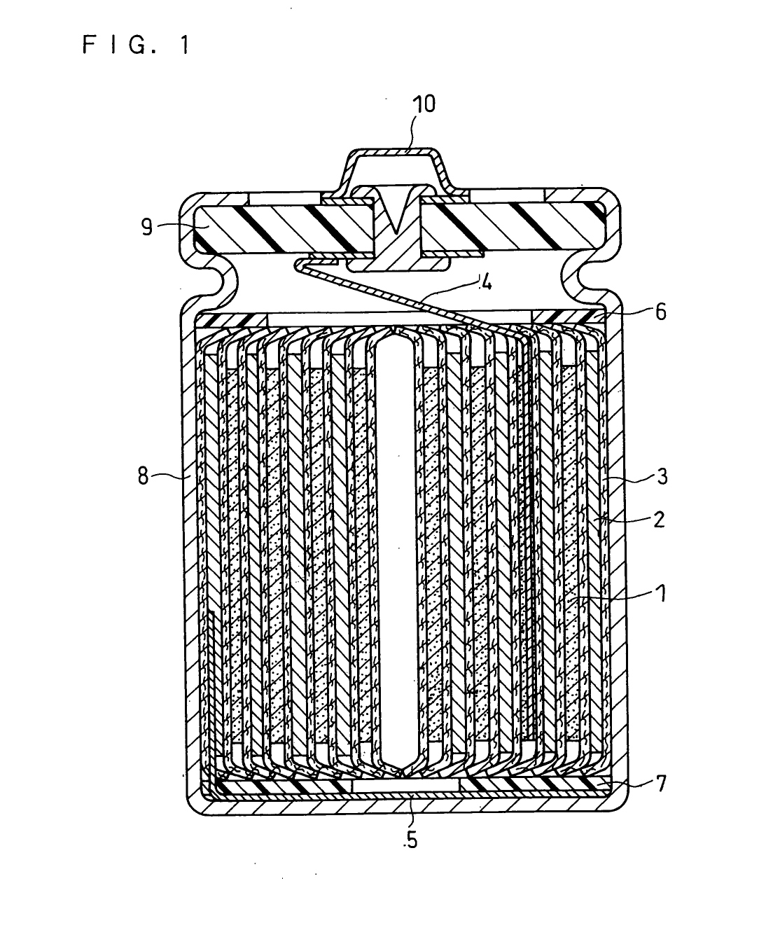

Various positive electrodes and negative electrodes were produced. Using the positive and negative electrodes, 18650-size cylindrical lithium ion secondary batteries as shown in FIG. 1 were produced.

(i) Production of Positive Electrode

Various positive electrode active materials (each having an average particle size D₅₀ of 10 μm) comprising lithium-containing composite oxides shown in Table 1 (namely, LiCoO₂, LiCo_{0.2}Ni_{0.8}O₂, LiCo_{0.15}Ni_{0.8}Al_{0.05}O₂ and LiC0_{0.33}Ni_{0.33}Mn_{0.33}O₂) were prepared by mixing a lithium hydroxide powder, a cobalt hydroxide powder, a nickel hydroxide powder, an aluminum hydroxide powder and a trimanganese tetroxide powder at specified ratios, followed by baking at 800° C. in an oxygen atmosphere.

Each of the positive electrode active materials was mixed with acetylene black (AB) as a conductive material and an aqueous emulsion of polytetrafluoroethylene (PTFE) as a binder at a specified weight ratio as shown in Table 1. Water as a dispersing medium was further added thereto, which was then kneaded to prepare a positive electrode material mixture slurry. This positive electrode material mixture slurry was applied onto both surfaces of a 20 μm thick positive electrode current collector comprising an aluminum foil using a comma coater, which was then dried and rolled with rollers to produce a positive electrode sheet. This positive electrode sheet was cut into a desired size and processed, to which a positive electrode lead 4 was welded. Thereby, a positive electrode 1 was produced.

(ii) Production of Negative Electrode

As the negative electrode active materials, the materials shown in Table 1 (namely, artificial graphite, Ti—Si alloy, simple substance of Si, simple substance of Sn, SiO and SnO) were used. The Ti—Si alloy, simple substance of Si, simple substance of Sn, SiO and SnO used here were purchased from Kojundo Chemical Lab. Co., Ltd. The Ti—Si alloy was prepared by mechanical alloying. The amounts of Ti and Si in the Ti—Si alloy were 37 wt % and 63 wt %, respectively. The obtained Ti—Si alloy was a two-phase alloy composed of a TiSi₂ phase and a Si simple substance phase. Each of the negative electrode active materials had a maximum particle size of 50 μm and an average particle size D₅₀ of 20 μm.

Each of the negative electrode active materials was mixed with acetylene black (AB) as a conductive material and an aqueous emulsion of styrene butadiene rubber (SBR) as a binder at a specified weight ratio as shown in Table 1. Water as a dispersing medium was further added thereto, which was then kneaded to prepare a negative electrode material mixture slurry. This negative electrode material mixture slurry was applied onto both surfaces of a 15 μm thick negative electrode current collector comprising a copper foil using a comma coater, which was then dried and rolled with rollers to produce a negative electrode sheet. This negative electrode sheet was cut into a desired size and processed, to which a negative electrode lead 5 was welded. Thereby, a negative electrode 2 was produced.

(iii) Preparation of Non-Aqueous Electrolyte

A non-aqueous electrolyte was prepared by dissolving lithium hexafluorophosphate (LiPF₆) in a solvent mixture containing ethylene carbonate and ethyl methyl carbonate serving as non-aqueous solvents at a volume ratio of 1:1, at a LiPF₆ concentration of 1 mol/liter.

(iv) Production of Battery

Using the positive and negative electrodes produced above, batteries were produced in the following procedure.

The positive electrode 1 and the negative electrode 2 were spirally wound with a separator 3 interposed therebetween. Thereby, an electrode group was produced. As the separator 3, a 25 μm thick polyethylene microporous film (available from Tonen Chemical Corporation) was used. Onto the top and bottom of the electrode group were placed an upper insulating plate 6 and a lower insulating plate 7, respectively, which was then housed into a battery case 8. The positive electrode lead 4 was welded to the underside of a sealing plate 9 equipped with a positive electrode terminal 10. The negative electrode lead 5 was welded to the inner bottom surface of the battery case 8. Subsequently, the non-aqueous electrolyte was injected into the battery case 8, after which the opening of the battery case 8 was sealed with the sealing plate 9. Thereby, a battery was produced. The batteries produced in this manner all had a design capacity of 2000 mAh. The charge/discharge voltage range was set from 4.3 V to 2.5 V.

(v) ARC Measurement

Each battery was charged at a constant current of 1 C to a battery voltage of 4.3 V. The battery was then charged at a constant voltage of 4.3 V until a current level became 0.05 C (100 mA). Note that, in all the batteries produced above, the capacity balance of the positive and negative electrodes was adjusted such that, when the battery voltage was 4.3 V, the potential of the positive electrode relative to that of lithium metal was 4.25 V and the potential of the negative electrode relative to that of lithium metal was 0.05 V. Moreover, after the charge operations, each battery was confirmed to have a capacity of 100% of the rated capacity.

In a dry air atmosphere having a dew point of −50° C., the positive and negative electrodes were removed from each battery in a charged state. They were then placed into a sealed container.

Using the sample sealed in the container, accelerating rate calorimetry was performed to determine a temperature T₁ at which the heat generation rate of the positive electrode reached the maximum and a temperature T₂ at which the heat generation rate of the negative electrode reached the maximum. The results are shown in Table 1.

The accelerating rate calorimeter used here was obtained from Thermal Hazard Technology. The conditions for ARC measurement were as follows:

temperature step: 20° C.,

wait time: 15 minutes,

temperature rate sensitivity: 0.04° C./min, and

calculation step temperature: 0.2° C.

TABLE 1

| | Temperature |
|---|---|
| | at which heat generation |
| | rate reaches the maximum |
| Electrode | in ARC measurement |
| LiCoO₂:AB:PTFE = 100:5:5 | 175° C. |
| LiCo_{0.2}Ni_{0.8}O₂:AB:PTFE = 100:5:5 | 162° C. |
| LiCo_{0.15}Ni_{0.8}Al_{0.05}O₂:AB:PTFE = 100:5:5 | 215° C. |
| LiCo_{0.33}Ni_{0.33}Mn_{0.33}O₂:AB:PTFE = 100:5:5 | 250° C. |
| Graphite:SBR = 100:3 | 255° C. |
| Graphite:AB:SBR = 100:10:3 | 225° C. |
| Ti—Si alloy:SBR = 100:5 | 291° C. |
| Ti—Si alloy:AB:SBR = 100:5:5 | 273° C. |
| Ti—Si alloy:AB:SBR = 100:8:5 | 265° C. |
| Ti—Si alloy:AB:SBR = 100:10:5 | 256° C. |
| Si powder:SBR = 100:5 | 280° C. |
| Sn powder:SBR = 100:5 | 285° C. |
| SiO powder:SBR = 100:5 | 290° C. |
| SnO powder:SBR = 100:5 | 295° C. |

The positive electrodes and the negative electrodes shown in Table 1 were combined as shown in Table 2 to produce batteries 1 to 22. In the batteries 3, 4, 9, 13, 16 and 18, the difference ΔT between T₁ and T₂ was less than 50° C. Accordingly, these can be regarded as comparative examples. In the batteries other than the above, the difference ΔT between T₁ and T₂ was equal to 50° C. or greater. Accordingly, they can be regarded as examples of the present invention.

TABLE 2

| Battery | Positive electrode | Negative electrode |
|---|---|---|
| 1 | LiCoO₂:AB:PTFE = 100:5:5 | Graphite:SBR = 100:3 |
| 2 | LiCo_{0.2}Ni_{0.8}O₂:AB:PTFE = 100:5:5 | Graphite:SBR = 100:3 |
| 3 | LiCo_{0.15}Ni_{0.8}Al_{0.05}O₂:AB:PTFE = 100:5:5 | Graphite:SBR = 100:3 |
| 4 | LiCo_{0.33}Ni_{0.33}Mn_{0.33}O₂:AB:PTFE = 100:5:5 | Graphite:SBR = 100:3 |
| 5 | LiCoO₂:AB:PTFE = 100:5:5 | Graphite:AB:SBR = 100:10:3 |
| 6 | LiCoO₂:AB:PTFE = 100:5:5 | Ti—Si alloy:SBR = 100:5 |
| 7 | LiCo_{0.2}Ni_{0.8}O₂:AB:PTFE = 100:5:5 | Ti—Si alloy:SBR = 100:5 |
| 8 | LiCo_{0.15}Ni_{0.8}Al_{0.05}O₂:AB:PTFE = 100:5:5 | Ti—Si alloy:SBR = 100:5 |
| 9 | LiCo_{0.33}Ni_{0.33}Mn_{0.33}O₂:AB:PTFE = 100:5:5 | Ti—Si alloy:SBR = 100:5 |
| 10 | LiCoO₂:AB:PTFE = 100:5:5 | Ti—Si alloy:AB:SBR = 100:5:5 |
| 11 | LiCo_{0.2}Ni_{0.8}O₂:AB:PTFE = 100:5:5 | Ti—Si alloy:AB:SBR = 100:5:5 |
| 12 | LiCo_{0.15}Ni_{0.8}Al_{0.05}O₂:AB:PTFE = 100:5:5 | Ti—Si alloy:AB:SBR = 100:5:5 |
| 13 | LiCo_{0.33}Ni_{0.33}Mn_{0.33}O₂:AB:PTFE = 100:5:5 | Ti—Si alloy:AB:SBR = 100:5:5 |
| 14 | LiCoO₂:AB:PTFE = 100:5:5 | Ti—Si alloy:AB:SBR = 100:10:5 |
| 15 | LiCo_{0.2}Ni_{0.8}O₂:AB:PTFE = 100:5:5 | Ti—Si alloy:AB:SBR = 100:10:5 |
| 16 | LiCo_{0.15}Ni_{0.8}Al_{0.05}O₂:AB:PTFE = 100:5:5 | Ti—Si alloy:AB:SBR = 100:10:5 |
| 17 | LiCo_{0.15}Ni_{0.8}Al_{0.05}O₂:AB:PTFE = 100:5:5 | Ti—Si alloy:AB:SBR = 100:8:5 |
| 18 | LiCo_{0.33}Ni_{0.33}Mn_{0.33}O₂:AB:PTFE = 100:5:5 | Ti—Si alloy:AB:SBR = 100:10:5 |
| 19 | LiCo_{0.15}Ni_{0.8}Al_{0.05}O₂:AB:PTFE = 100:5:5 | Si powder:SBR = 100:5 |
| 20 | LiCo_{0.15}Ni_{0.8}Al_{0.05}O₂:AB:PTFE = 100:5:5 | Sn powder:SBR = 100:5 |
| 21 | LiCo_{0.15}Ni_{0.8}Al_{0.05}O₂:AB:PTFE = 100:5:5 | SiO powder:SBR = 100:5 |
| 22 | LiCo_{0.15}Ni_{0.8}Al_{0.05}O₂:AB:PTFE = 100:5:5 | SnO powder:SBR = 100:5 |

A thermocouple was attached onto the surface of each battery. Then, an overcharge test (a test in which each battery was charged to 150% of its rated capacity) was performed at a current level of 1 C at 0° C. Table 3 shows the maximum surface temperature for each battery.

TABLE 3

| | Maximum surface temperature obtained |
|---|---|
| Battery | when overcharged at 1 C at 0° C. |
| 1 | 57° C. |
| 2 | 58° C. |
| 3 | 68° C. |
| 4 | 78° C. |
| 5 | 59° C. |
| 6 | 55° C. |
| 7 | 57° C. |
| 8 | 52° C. |
| 9 | 62° C. |
| 10 | 66° C. |
| 11 | 58° C. |
| 12 | 54° C. |
| 13 | 67° C. |
| 14 | 57° C. |
| 15 | 58° C. |
| 16 | 68° C. |
| 17 | 55° C. |
| 18 | 78° C. |
| 19 | 52° C. |
| 20 | 51° C. |
| 21 | 52° C. |
| 22 | 53° C. |

As can be seen from Tables 2 and 3, in the batteries in which ΔT obtained from the ARC measurement of the positive and negative electrodes was equal to 50° C. or greater, the maximum surface temperature was suppressed to not greater than 60° C. Among the batteries in which ΔT was the same level as above (i.e., ΔT being equal to 50° C. or greater), the batteries whose T₁ (i.e., the temperature at which the heat generation rate of the positive electrode reached the maximum) was 215° C. or greater had a low maximum surface temperature. Specifically, the maximum surface temperature was suppressed to 55° C. or lower.

In contrast, in the batteries in which ΔT was less than 50° C., the maximum surface temperature exceeded 60° C.

As described above, the lithium ion secondary battery of the present invention has a high energy density and excellent stability. The application of the lithium ion secondary battery of the present invention is not specifically limited, but it is particularly useful as a power source for portable devices such as cell phones and notebook computers.

Although the examples given above illustrate embodiments in which LiCoO₂, LiCo_{0.2}Ni_{0.8}O₂, LiCo_{0.15}Ni_{0.8}Al_{0.05}O₂ and LiCo_{0.33}Ni_{0.33}Mn_{0.33}O₂ are employed as the positive electrode active material, and artificial graphite, Ti—Si alloy, simple substance of Si, simple substance of Sn, SiO and SnO are employed as the negative electrode active material, similar results are obtained using active materials other than the above.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A lithium ion secondary battery comprising a positive electrode capable of absorbing and desorbing lithium ions, a negative electrode capable of absorbing and desorbing lithium ions, and a non-aqueous electrolyte,
wherein a difference ΔT between a temperature T₁ and a temperature T₂ is equal to 50° C. or greater, where said T₁ is a temperature at which the heat generation rate of said positive electrode in a charged state reaches the maximum, and said T₂ is a temperature at which the heat generation rate of said negative electrode in a charged state reaches the maximum.

2. The lithium ion secondary battery in accordance with claim 1, wherein said temperature T₁ is not less than 215° C.

3. The lithium ion secondary battery in accordance with claim 1,
wherein said positive electrode comprises a positive electrode active material, a conductive material and a binder, and
said positive electrode active material is represented by the formula LiₓCo_{1-y-z}Ni_{y}M_{z}O₂, where 0.95≦x≦1.1, 0≦y≦0.9, 0≦z≦0.5, and M is at least one element selected from the group consisting of Al, Mn, Mg, Ti, V, Fe, Cu and Zn.

4. The lithium ion secondary battery in accordance with claim 1,
wherein said negative electrode comprises a negative electrode active material and a binder, and
said negative electrode active material comprises at least one selected from the group consisting of carbon material, Si, Si alloy, Si oxide, Sn, Sn alloy and Sn oxide.

5. A charging system for a lithium ion secondary battery comprising a lithium ion secondary battery and a charger for charging said lithium ion secondary battery,
said lithium ion secondary battery comprising a positive electrode capable of absorbing and desorbing lithium ions, a negative electrode capable of absorbing and desorbing lithium ions, and a non-aqueous electrolyte,
wherein said charger has a function to terminate charging when said lithium ion secondary battery is at a state of charge of not less than 90% relative to its rated capacity, and
a difference ΔT between a temperature T₁ and a temperature T₂ is equal to 50° C. or greater, where said T₁ is a temperature at which the heat generation rate of the positive electrode contained in said lithium ion secondary battery at a state of charge of not less than 90% relative to its rated capacity reaches the maximum, and said T₂ is a temperature at which the heat generation rate of the negative electrode contained in said lithium ion secondary battery at a state of charge of not less than 90% relative to its rated capacity reaches the maximum.
